(19) United States
(12) Patent Application Publication
(10) Pub. No.: US 2024/0428118 A1
(43) Pub. Date: Dec. 26, 2024

(54) SYSTEM AND METHOD FOR ARTIFICIAL INTELLIGENCE-BASED DIGITAL DATA STEWARD IMPLEMENTATION

(71) Applicant: Cognizant Technology Solutions U.S. Corp., Teaneck, NJ (US)

(72) Inventors: Sandeep UPADHYAY, Wheeling, IL (US); Tritoy BANERJEE, Hamilton, NJ (US); Tushar SINHA, Frisco, TX (US)

(73) Assignee: Cognizant Technology Solutions U.S. Corp., Teaneak, NJ (US)

(21) Appl. No.: 18/212,975

(22) Filed: Jun. 22, 2023

(51) Int. Cl. G06N 20/00

(52) U.S. Cl. CPC G06N 20/00

(57) ABSTRACT

The present invention provides for a system and a method for implementing artificial intelligence-based optimised data stewardship. The system comprises a memory for storing program instructions, a processor executing instructions stored in the memory and a digital data stewardship engine executed by the processor. One or more events are identified based on nature of the events and a sequence is determined for invoking one or more units of the digital data stewardship engine based on the identified event. Machine learning-based intelligent analysis is performed on additional information obtained through third-party websites associated with the identified event. Rules are applied on the results of the intelligent analysis for augmenting the results as per pre-defined requirements and outcome generated based on application of rules are delivered as an executable file.

### FIELD OF THE INVENTION

The present invention relates generally to data processing and analytics, and more particularly, the present invention relates to a system and method for artificial intelligence based optimized data stewardship operations.

### BACKGROUND

Typically, for instance, in life sciences organizations, data stewardship plays an important role across multiple business functions such as commercial operations, research and development, manufacturing, supply chain, operations and finance etc. Data stewardship is defined as management of data assets to provide various units of the organizations with data insights. Also, each of the units requires different entities to be mastered based on usage. For example, in life sciences organizations commercial units require healthcare practitioner's master data for multiple processes such as territory alignment for sales representatives, incentive compensations or having right specialization for each healthcare practitioners for a sample drop. Every time the entity is mastered within a unit or across various units of the organization, there is a need for data stewardship which is a time-consuming process. Also, there is a need to have a curated list of entities that are a part of the business processes. The curated list of customers, doctors, vendors, products and other entities from multiple sources provides information in the form of a plurality of data records. Furthermore, as businesses grow, data records also increase in volumes internally along with number of people and, therefore, existing Master Data Management (MDM) systems require highly human intensive data stewardship to cater to business needs of the organization. Existing MDM systems face a lot of stewardship challenges in terms of manual incentive work and complexity.

Existing MDM systems operate by creating a single, unified, trusted profile of entities (customers, products, suppliers, location etc.) from multiple sources/source systems. Typically, the profiles are a single source of repository for organizations for multiple operations. FIG. 2 illustrates an exemplary prior art MDM system at a high level depicting a plurality of data sources received by the MDM system. It has been observed that match rates of data records across sources in the MDM systems are highly dependent on quality of underlying data in plurality of data profiles in source systems and match rule configuration within the MDM systems. While MDM systems are generally good at matching data records across sources, the match rates tend to vary between 80%-90% depending on the quality of underlying data in the source systems, and the match rule configuration within the MDM system.

Therefore, post MDM implementation there is a need of data stewardship team whose job is to manually review the potential match records and increase the match rates by following various techniques such as data validation (correcting inaccurate profile attributes), data enrichment (augment the profile attributes from additional data sources), data standardization (converting data into standard formats) etc. In addition, the data stewardship teams also manage the data change requests from business teams and any other system-based requests to add/change the master data. These requests are mostly based around adding/editing/deleting/confirming data attributes (example—adding a new entity, modifying entity profile attributes, removing inactive entities etc.)

However, manual data stewardship of the match records is prone to a plethora of challenges. Furthermore, data stewardship task is a significant manual exercise where a person reviews each instance of the matched records or a data change request for categorizing into appropriate resolution pattern and then follows Standard Operating Procedure (SOP) for resolution. FIG. 3 illustrates a high-level process flow diagram of an example conventional human based data stewardship process.

Also, in such human based data stewardship process, resolution time varies from 10 minutes to 15 minutes across different resolution scenarios. Further, post MDM implementation for potential match records, in life sciences industry, for instance, has queues ranging between 500,000 to millions of records which is not humanely possible to process and resolve, without spending significant time, human effort/resources, and money. Also, there are daily and weekly intake of new master data records (such as a new healthcare practitioner or a healthcare organization). Further, data stewardship is a recurrent annual expenditure for an organization, and it may increase over years as more data sources and entities are added in the MDM system.

In light of the above drawbacks, there is a need for a system and a method for artificial intelligence based optimized data stewardship operations. There is a need for performing optimized data stewardship in an accurate and secured manner. Further, there is a need for performing digital data stewardship by optimally analyzing match records and resolving potential match records in a faster, accurate and efficient manner. Also, there is a need for an integrated platform for carrying out data stewardship operations for a huge volume of datasets from different sources with minimum human intervention.

### SUMMARY OF THE INVENTION

In various embodiments of the present invention, a system for implementing artificial intelligence-based optimised data stewardship is provided. The system comprises a memory for storing program instructions and a processor for executing instructions stored in the memory and a digital data stewardship engine executed by the processor. The digital data stewardship engine is configured to identify one or more events based on nature of the events and determine a sequence for invoking one or more units of the digital data stewardship engine based on the identified event. The digital data stewardship engine is configured to perform machine learning-based intelligent analysis on additional information obtained through third-party websites associated with the identified event. The digital data stewardship engine is configured to apply rules on the results of the intelligent analysis for augmenting the results as per pre-defined requirements and deliver an outcome generated based on application of rules as an executable file.

In various embodiments of the present invention, a method for implementing artificial intelligence-based optimised data stewardship is provided. The method is implemented by a processor executing program instructions stored in a memory. The method comprises identifying one or more events based on nature of the events and determining a sequence for invoking one or more units of the digital data stewardship engine based on the identified event. The method comprises performing machine learning-based intelligent analysis on additional information obtained through third-party websites associated with the identified event and applying rules on the results of the intelligent analysis for augmenting the results as per pre-defined requirements. The method comprises delivering an outcome generated based on application of rules as an executable file.

In various embodiments of the present invention, a computer program product is provided. The computer program product comprises a non-transitory computer-readable medium having computer program code stored thereon. The computer-readable program code comprises instructions that, when executed by a processor, causes the processor to identify one or more events based on nature of the events. A sequence is determined for invoking one or more units of a digital data stewardship engine based on the identified event. Machine learning-based intelligent analysis is performed on additional information that is obtained through third-party websites associated with the identified event. Rules are applied on the results of the intelligent analysis for augmenting the results as per pre-defined requirements. Outcome generated based on application of rules are delivered as an executable file.

### BRIEF DESCRIPTION OF THE ACCOMPANYING DRAWINGS

The present invention is described by way of embodiments illustrated in the accompanying drawings wherein;

FIG. 1 illustrates a block diagram of an artificial intelligence-based optimized data stewardship system 100, in accordance with an embodiment of the present invention;

FIG. 2 illustrates a prior art Master Data Management (MDM) system at a high level;

FIG. 3 illustrates a high-level process flow diagram of conventional data stewardship;

FIGS. 4 and 5 illustrate a process flow diagram of conventional data stewardship involving human stewards;

FIGS. 6a and 6b illustrate a potential match record processing carried out by the system 100, in accordance with another embodiment of the p resent invention;

FIG. 7 illustrates actions performed by the system 100 to process the potential match record for applying rules to resolve the potential match record, in accordance with an embodiment of the present invention;

FIG. 8 illustrates a semi-autonomous potential match resolution carried out by the system 100, in accordance with an embodiment of the present invention;

FIG. 9 illustrates a fully autonomous match resolution carried out by the system 100, in accordance with an embodiment of the present invention;

FIG. 10 illustrates a conventional Data Change request (DCR) summary generated by the system 100;

FIG. 11 illustrates a Data Change request (DCR) summary, in accordance with another embodiment of the present invention;

FIG. 12 illustrates a fully automated DCR resolution performed by the system 100, in accordance with an embodiment of the present invention;

FIG. 13 is a flowchart illustrating a method for an artificial intelligence based optimized data stewardship, in accordance with an embodiment of the present invention; and

FIG. 14 illustrates an exemplary computer system, in accordance with an embodiment of the present invention.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

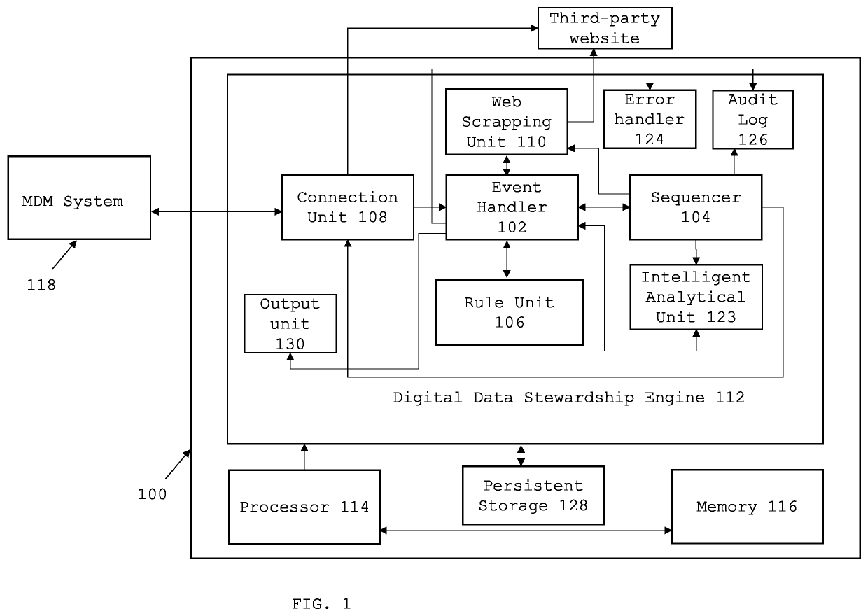

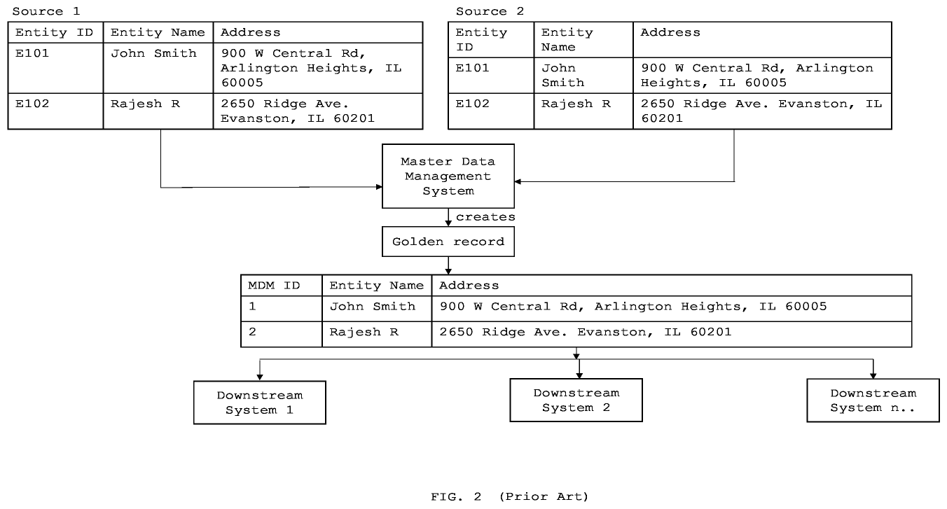

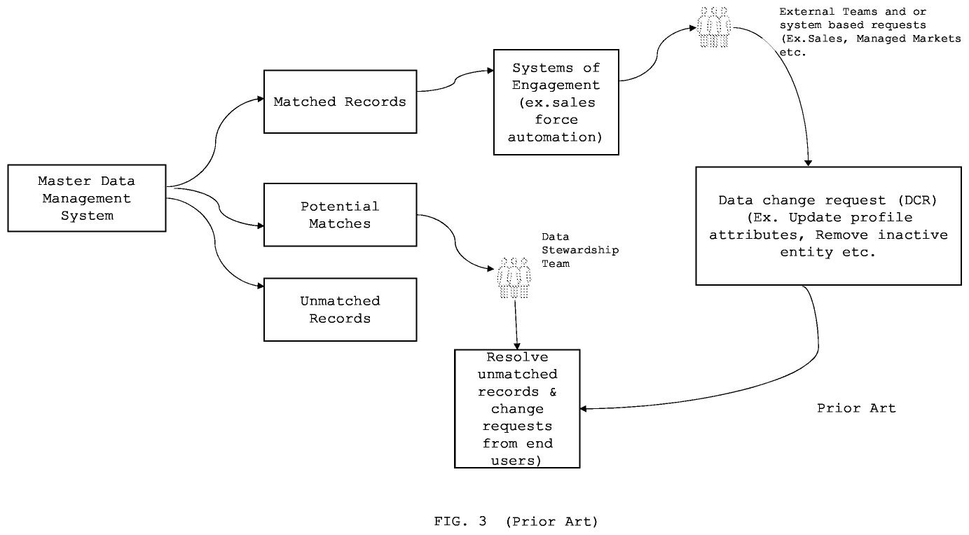

FIG. 1 is a block diagram of an artificial intelligence-based optimized digital data stewardship system 100 (also referred as system 100), in accordance with various embodiments of the present invention. In an embodiment of the present invention, the system 100 comprises a digital data stewardship engine 112 communicatively connected to a Master Data Management (MDM) system 118. The components of the digital data stewardship engine 112 are operated via a processor 114 specifically programmed to execute instructions stored in a memory 116 for executing respective functionalities of the components of the system 100. The digital data stewardship engine 112 comprises an event handler 102, a sequencer 104, a rule unit 106, a connection unit 108, a web scrapping unit 110, an intelligent analytical unit 123, an error handler 124, an audit log 126, a persistent storage 128, and an output unit 130.

In an embodiment of the present invention, the digital data stewardship engine 112 is an integrated platform created through Robotic Process Automation (RPA) platforms in conjunction with Artificial intelligence (AI) based Cognitive Process Automation (CPA) platforms. Examples of RPA platforms are Blue Prism®, Nile®, UI Path® etc. Examples of CPA platforms are AWS SageMaker®, Azure AI® etc. The system 100 is capable of processing a myriad of data from different sources and expedites rate at which an optimized data stewardship task is resolved, apart from minimizing and/or completely eliminating need of manual data stewardship. In an embodiment of the present invention, the digital data stewardship engine 112 is configured to perform continuous improvement through reinforced learning and unsupervised learning that is used for processing of a plurality of datasets.

In an embodiment of the present invention, the system 100 may be implemented in a cloud computing architecture in which data, applications, services, and other resources are stored and delivered through shared data-centres. In an exemplary embodiment of the present invention, the functionalities of the system 100 are delivered to a user as Software as a Service (SaaS) or Platform as a Service (PaaS) over a communication network. The system 100 is a micro-service-based architecture comprising micro-service components which communicate via an Application Programming Interface (API).

In another embodiment of the present invention, the system 100 may be implemented as a client-server architecture. In an embodiment of the present invention, a client terminal accesses a server hosting the system 100 over a communication network. The client terminals may include but are not limited to a smart phone, a computer, a tablet, microcomputer or any other wired or wireless terminal. The server may be a centralized or a decentralized server. The server may be located on a public/private cloud or locally on a particular premise.

In an embodiment of the present invention, the event handler 102 of the digital data stewardship engine 112 is configured to actively listen for occurrence of one or more events and identify the events based on nature of the events. In an exemplary embodiment of the present invention, the one or more events may be a first event including an update of the MDM system 118 match queue. Typically, a match queue of the MDM system 118 includes potential match records which are not a definite match and require resolution. The MDM system 118 fetches and stores a plurality of datasets from one or more sources. The MDM system 118 performs a matching operation on the datasets based on a set of data correlation rules to categorize the plurality of datasets into a definite match record, a potential match record and a no match records. The definite match record is a record of a completely matched dataset. The potential match record is a record of dataset with potential match amongst the datasets which are sent to the match queue for implementing resolution patterns. The no match record is a record of datasets without any match. The updating of the match queue by the MDM system 118 triggers the event handler 102 of the digital data stewardship engine 112, and the event handler 102 recognizes the updating of the match queue as the event.

In another exemplary embodiment of the present invention, the one or more events may be a second event including a data change request made to the MDM system 118. The data change requests can come from business users and/or systems. Examples of data change request include requests made to the MDM system 118 around various data attributes including, but are not limited to, adding a new entity, modifying entity profile attributes, and removing inactive entities across various business functions of an organization, for instance, life sciences organization such as commercial functions, business functions, research and development, manufacturing, supply chain operations. Examples of entities include, but are not limited to, healthcare practitioners, healthcare organization, patient product, supplier, vendor, CRO site studies product, supplier plant material, distributer material, logistics partners etc. In another exemplary embodiment of the present invention, the one or more events may include a third event including a user input received by the MDM system 118 or the digital data stewardship engine 112.

In an embodiment of the present invention, the digital data stewardship engine 112 is communicatively connected to the MDM system 118 and third-party websites through the connection unit 108. The connection unit 108 stores details needed for connection to the MDM system 118 and third-party websites. In an exemplary embodiment of the present invention, the connection unit 108 allows data connection into and out of the digital data stewardship engine 112 via a plurality of batch connection streams and/or Application Program Interface (API) based exchange. In another exemplary embodiment of the present invention, the connection unit 108 allows inbound and outbound connection to the MDM system 118. In another exemplary embodiment of the present invention, the connection unit 108 establishes a plurality of connections to the MDM system's 118 backend database tables as well as API based calls depending on specifics of the MDM system 118. In yet another embodiment of the present invention, connection unit 108 allows inbound data feeds from external third-party websites.

In an embodiment of the present invention, the event handler 102 is triggered for taking actions on the events based on event triggers. The event triggers include time-based triggers or on-demand triggers. Upon triggering, the event handler 102 invokes the sequencer 104. The sequencer 104 determines the sequence in which other units of the digital data stewardship engine 112 need to be invoked for the identified event.

In an exemplary embodiment of the present invention, the event handler 102 identifies the first event i.e., MDM match queue update (potential match queue). The sequencer 104 implements a sequence of actions associated with invocation of the other units of the digital data stewardship engine 112 for the potential match scenario based on the event handler's 102 recognition of a potential match queue addition. Firstly, the sequencer 104 invokes the connection unit 108 to get connected to the third-party websites. Secondly, the sequencer 104 invokes the web scrapping unit 110 to extract additional information from the connected third-party websites for resolving the potential match dataset in the match queue. The web scrapping unit 110 employs batch connection streams and/or API based exchange to extract the additional information. The event handler 102 identifies the additional information received from the web scrapping unit 110 and sends the additional information to the intelligent analytical unit 123.

In an embodiment of the present invention, the intelligent analytical engine 123 uses natural language processing to parse the additional information that includes structured and unstructured content. In an embodiment of the present invention, the intelligent analytical engine 123 implements an information extractor (not shown) to detect matched dataset corresponding to the potential match dataset from the additional information and extract text associated with the additional information. In an example, data associated with healthcare practitioners are matched on NPPES, IQVIA or MedPro portals and additional information such as National Provider Identification (NPI) number, Drug Enforcement Agency (DEA) etc. are extracted for determining a match. The intelligent analytical unit 123 then classifies the additional information. For example, a 10-digit number identified on NPPES website is automatically classified as NPI by the intelligent analytical unit 123. In an exemplary embodiment of the present invention, the intelligent analytical unit 123 employs machine learning-based algorithm for intelligent classification of the additional information for further usage. After classification, the intelligent analytical unit 123 employs machine learning-based contextual matching for resolving the potential matches in the potential match queue. In an exemplary embodiment of the present invention, the intelligent analytical unit 123 performs contextual matching to identify duplicates of a specific entity type. For example, healthcare practitioner specific attributes (e.g., first name, last name, address, identifiers etc.) are employed for the contextual matching.

In an embodiment of the present invention, the intelligent analytical unit 123 stores codification of a business process in discrete actions for resolving the potential matches in the match queue. For example, A1: Log in to system x, A2: Access Y, A3: Parse Records under Z, A4, for each record, do the following actions A1, A2, A3, A4 etc. The intelligent analytical unit 123 also stores evaluation rules associated with each of the actions. An example of evaluation rule for an action A4 is If x-y then get z from source X and replace z in source Y. In an embodiment of the present invention, the intelligent analytical unit 123 analyzes efficacy of the actions and evaluation rules in terms of efficiency and accuracy of results and overrides and updates the actions and evaluation rules continuously.

In an exemplary embodiment of the present invention, the intelligent analytical unit 123 uses machine language-based response models to predict outcomes based on results of the contextual matching. In another exemplary embodiment of the present invention, the intelligent analytical unit 123 uses patterns in the results of the contextual match to refine the machine learning-based response models without any human intervention, as unsupervised learning. In yet another exemplary embodiment of the present invention, the intelligent analytical unit 123 uses previously analysed and resolved datasets as initial learning for the machine learning-based response models, as supervised learning. For example, the machine learning-based response models are fed with prior data steward resolution of potential match datasets to train the machine learning-based response models on healthcare practitioner or healthcare organization matches. In an exemplary embodiment of the present invention, in case of man-machine combination scenario, the connection unit 108 allows human data stewards to upload final match decisions to refine learning datasets or provide inputs to re-train the machine learning-based response models. The intelligent analytical unit 123 sends the results of contextual matching to the event handler 102.

In an embodiment of the present invention, the event handler 102 invokes the error handler 124 for detecting errors in the processing steps of the digital data stewardship engine 112. The error handler 124 stores error logs containing details of issues and errors encountered during execution, including logs for handled and unhandled exceptions. For example, a detected error may include receiving non-USA country code for processing potential match if the intelligent analytical unit 123 is trained and licensed for only USA use. In another embodiment of the present invention, the event handler 102 invokes the audit log 126 if required. The audit log 126 stores a trace log for every execution run of the digital data steward engine 112. In another embodiment of the present invention, the sequencer 104 employs audit logs to prepare a match output report and also employs results of error handling based on requirement.

In an embodiment of the present invention, the persistent storage 128 of the digital data stewardship engine 112 stores execution operational output data and summary results of the processing and resolution of the potential match queue. The persistent storage also stores all inbound datasets, outputs generated, Artificial Intelligence (AI) learning weights, potential match queue record details (name, address, external identifiers) and match outcomes.

In an embodiment of the present invention, the event handler 102 invokes the rule unit 106 for processing the results of contextual matching. The rule unit 106 is a repository of a plurality of rules for the entire data stewardship operation based on business requirements of different organizations. In an exemplary embodiment of the present invention, the rule unit 106 is configured to augment results of the contextual matching by the intelligent analytical unit 123 and generate outcomes consistent with organization defined business rules. In an example, rule may be defined as: If DEA number is a match across two records, consider records for matching only if state code of address is same, otherwise mark as not a match.

In an embodiment of the present invention, the event handler 102 creates a merged dataset of the resolved potential match record for delivering as an executable file via the output unit 114. The output unit 130 is also configured to fetch the match output report from the sequencer 104 for display on a User Interface (UI) linked to the output unit 130.

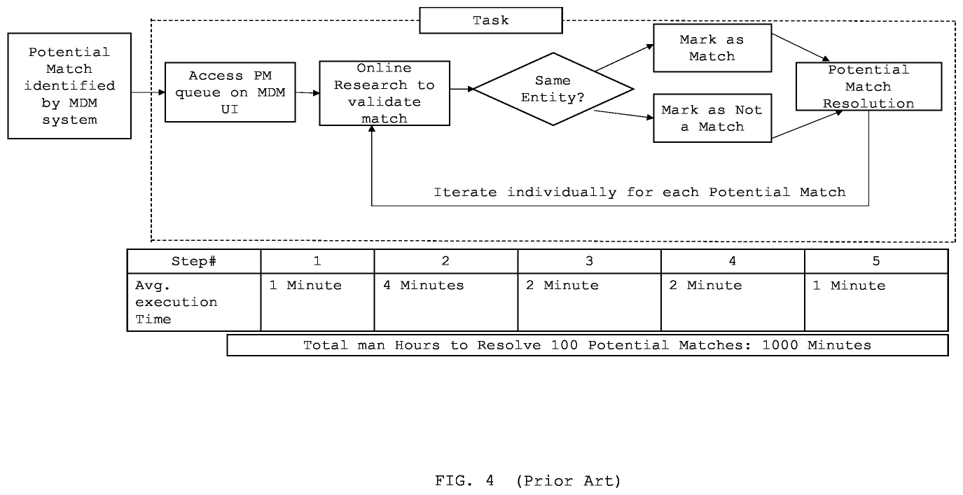

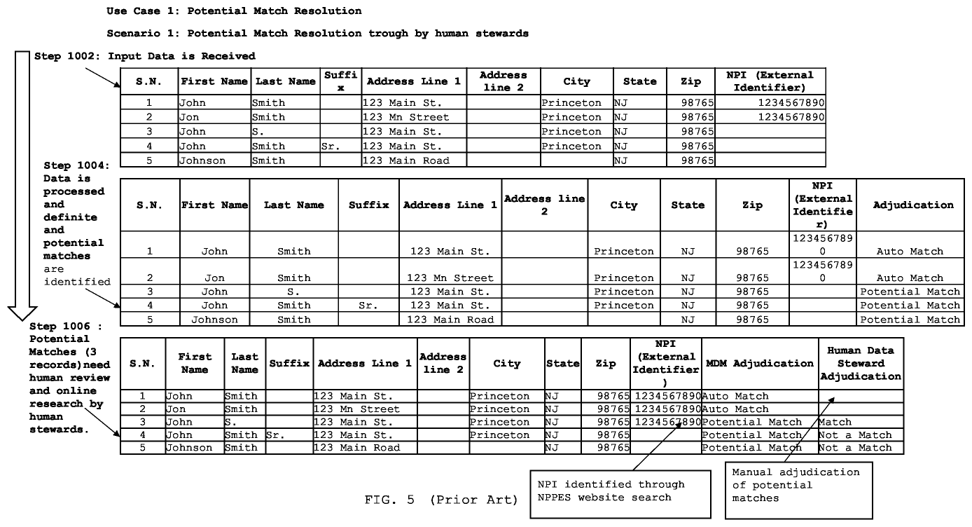

Table 1 below illustrates conventional data steward technique for manual potential match record resolution corresponding to a data steward activity as illustrated in FIG. 4. FIG. 5 also illustrates a flow diagram for identification of definite and potential match record and processing of potential match record carried out conventionally by human stewards.

TABLE 1

| Step | | Time Taken | |
|---|---|---|---|
| No. | Step Details | (Average) | |
| 1. | Manual data steward logins into MDM web UI and | 1 | minute |
| | navigates to a screen with potential matches. The | | |
| | data steward manually selects a specific | | |
| | Healthcare Practitioner (HCP) match pair from a | | |
| | list of such matches and opens a detailed view to | | |
| | review match details. | | |
| 2 | The data steward performs online research based | 4 | minutes |
| | on information on the HCP. Below online portals | | |
| | are used to perform research. | | |
| | 1. National Plan and Provider Enumeration | | |
| | System (NPPES) - This is used to perform | | |
| | search based on name OR address or NPI | | |
| | (unique 10 digit identifier) or a | | |
| | combination of the same. If a match is | | |
| | identified, the manual data steward keeps a | | |
| | note of information. | | |
| | 2. American Medical Association (AMA) - | | |
| | This is used to search based on number of | | |
| | HCPs. If a match is identified, the manual | | |
| | data steward keeps a note of information. | | |
| | 3. OneKey or MedPro Portals - These portals | | |
| | are 3rd data provider portals providing | | |
| | access to HCP details. If a match is | | |
| | identified, the manual data steward keeps a | | |
| | note of information. | | |
| | 4. Hospital (Organization) Websites - These | | |
| | websites are for organization and may be | | |
| | used to lookup departments of organization | | |
| | or HCPs working in organization. | | |
| | 5. Other Social Media Websites - These | | |
| | websites are optionally used for search | | |
| | when above mentioned portals do not yield | | |
| | good matches. | | |
| 3 | Based on information collected/noted in the step 3, | 2 | minutes |
| | the manual data steward adjudicates match and | | |
| | decision is taken based on information overlap for | | |
| | match pair | | |
| 4 | The manual data steward navigates back to the | 2 | minutes |
| | MDM web UI and performs a few iterations to | | |
| | mark record pair as a “Match” or “Not a Match” | | |
| 5 | The manual data steward navigates back to | 1 | Minute |

potential match queue and picks up a new record
pair for resolution. The steps 1-4 are repeated till
end of the queue is reached

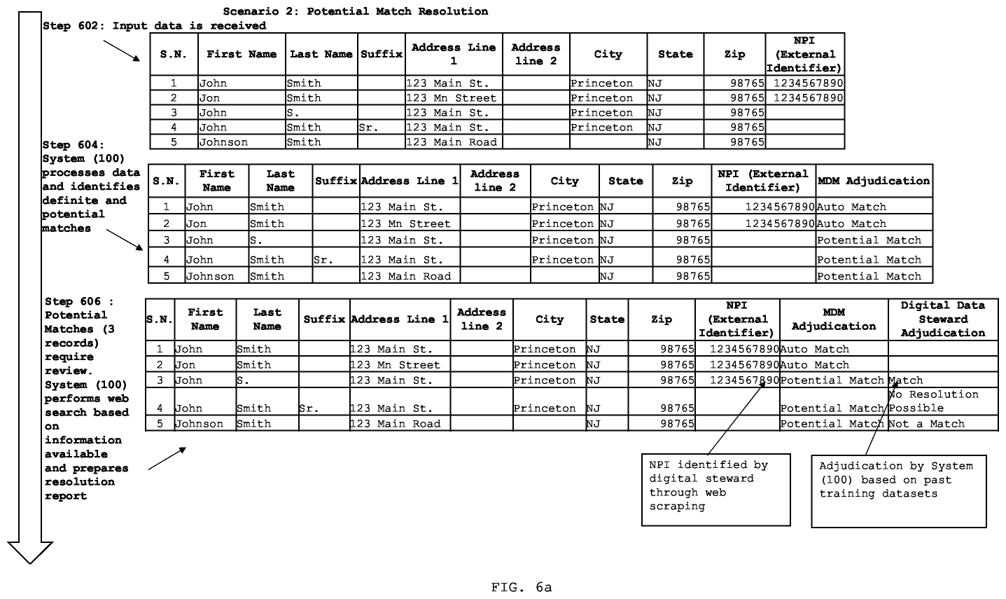

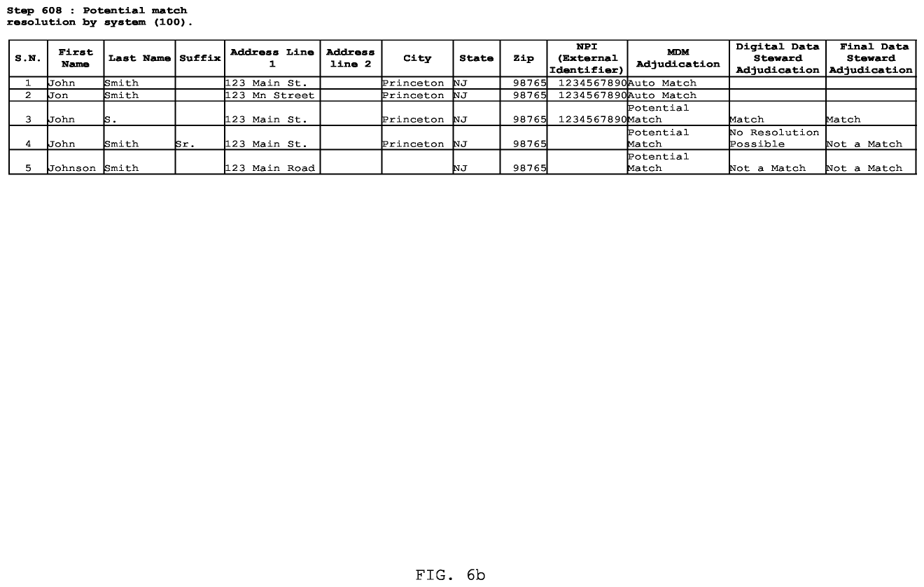

FIGS. 6a and 6b illustrate a potential match record processing carried out by the system 100, in accordance with an exemplary embodiment of the present invention. As shown in FIGS. 6a and 6b, at step 602, input data is received and at step 604, system 100 processes data and identifies definite and potential match record. At step 606, it is determined that potential matches require review and system 100 performs web search based on information available and prepares resolution report. At step 608, potential match record processing is carried out by the system 100.

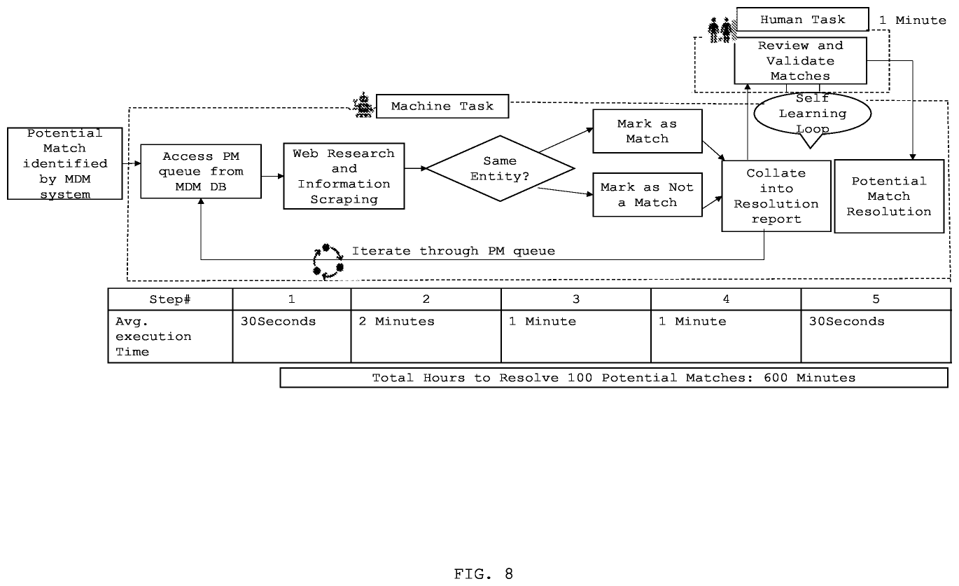

Table 2 and FIG. 8 illustrate a semi-autonomous potential match resolution carried out by the system 100, in accordance with an embodiment of the present invention.

TABLE 2

| Step | | | |
|---|---|---|---|
| No. | Step Details | Time Taken | |
| 1 | The system 100 accesses record match pairs from | 30 | seconds |
| | the MDM database (in the matching unit 104 (not | | |
| | shown)) or through real time API calls | | |
| 2 | The system 100 uses name, address and identifier | 2 | minutes |
| | information on the match record pairs to perform a | | |
| | search on the below web portals: | | |
| | 1. National Plan and Provider Enumeration | | |
| | System (NPPES) | | |
| | 2. American Medical Association (AMA) | | |
| | databases - | | |
| | 3. OneKey or MedPro Portals | | |
| | 4. Hospital (Organization) Websites | | |
| | 5. Other Social Media Websites | | |
| | If matching information is identified, the system | | |
| | 100 gathers additional attributes for record using | | |
| | web scraping. This information is captured in a | | |
| | pre-defined template for presenting to the system | | |
| | 100. | | |
| 3 | The system 100 uses information captured to make | 1 | minute |
| | a decision on the record pair (match vs. not a | | |
| | match). The system 100 is trained to take match | | |
| | decisions based on training datasets from prior | | |
| | human data steward activities. | | |
| 4 | The system 100 iterates through entire potential | 1 | minute |
| | match queue (above steps) and collate match | | |
| | decisions into a single resolution report for review | | |
| | by a human data stewards. | | |
| 5 | Human data steward reviews resolution report and | 1 | minute |
| | validates veracity of match decision identified by | | |
| | the system 100. | | |
| | Human steward may override decisions by the | | |
| | system 100 if deemed necessary. Also, overrides | | |
| | are utilized by the system 100 to refine ML models | | |
| | for future matching accuracy improvement. | | |
| 6 | The system 100 takes final resolution report and | 30 | Seconds |

applies match decisions either through database
updates in batch or real time API calls

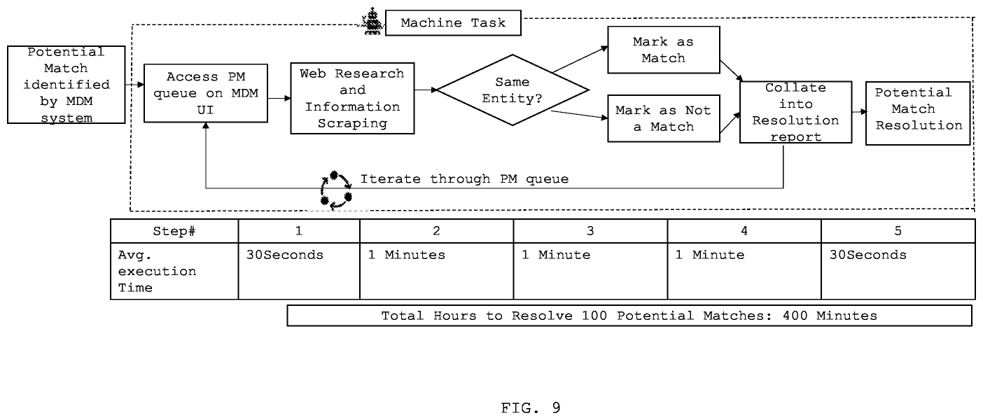

Table 3 and FIG. 9 illustrate a fully autonomous potential match resolution carried out by system 100, in accordance with an embodiment of the present invention.

TABLE 3

| Step | | | |
|---|---|---|---|
| No. | Step Details | Time Taken | |
| 1 | The system 100 accesses record match pairs from | 30 | seconds |
| | the MDM database or through real time API calls | | |
| 2 | The system 100 uses name, address and identifier | 1 | minute |
| | on match record pairs to perform a search on the | | |
| | below web portals | | |
| | 1. National Plan and Provider Enumeration | | |
| | System (NPPES) | | |
| | 2. American Medical Association (AMA) | | |
| | databases - | | |
| | 3. OneKey or MedPro Portals | | |
| | 4. Hospital (Organization) Websites | | |
| | 5. Other Social Media Websites | | |
| | If matching information is identified, the system | | |
| | 100 gathers additional attributes for record using | | |
| | web scraping. The matching information is | | |
| | captured in a pre-defined template for presenting to | | |
| | the system 100 | | |
| 3 | The system 100 uses information captured to make | 1 | minute |
| | a decision on the record pair (match vs. not a | | |
| | match). The system 100 is trained to take match | | |
| | decisions based on training datasets from prior | | |
| | human data steward activities. | | |
| 4 | The system 100 iterates through entire potential | 1 | minute |
| | match queue (steps above) and collates match | | |
| | decisions into a single resolution report. | | |
| 5 | The system 100 takes the final resolution report | 30 | seconds |

and applies the match decisions either through
database updates in batch or real time API calls.

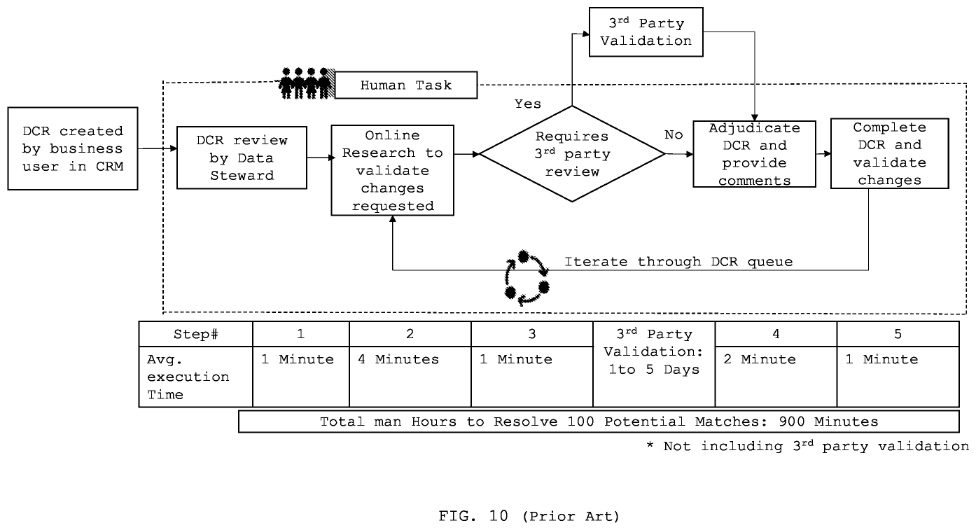

Table 4 and FIG. 10 illustrate a conventional Data Change request (DCR) summary.

TABLE 4

| Step | | Time Taken | |
|---|---|---|---|
| No. | Step Details | (Average) | |
| 1 | DCR record is accessed manually and nature of the | 1 | minute |
| | DCR record and information request is assessed: | | |
| | 1. New Customer request - Request to approve | | |
| | a new HCP in the customer universe | | |
| | 2. Edit Customer request - Request to approve | | |
| | changes to a customer such as specialty, | | |
| | status, address addition or inactivation etc. | | |
| 2 | The Initial validation is performed manually to | 4 | minutes |
| | verify the request | | |
| | Typically, this involves researching for customer on | | |
| | 3rd party data provider websites (OneKey or | | |
| | MedPro), NPPES and organization websites | | |
| 3 | A human steward decides whether a 3rd party data | 1 | minute |
| | provider primary review is required to validate the | | |
| | DCR. Based on this, information (such as industry | | |
| | identifiers like NPI, phone number etc.) on the DCR | | |
| | is captured and reviewed by 3rd party provider | | |
| | (example IQVIA or MedPro) | | |
| 4 | The 3rd party provider validates the request and | N/A (since its | |
| | shares response back | outside the purview | |
| | | of the companies' | |
| | | data stewards) | |
| 5 | A human steward reviews response back from the | 2 | minutes |
| | 3rd party provider. Based on the response, it is | | |
| | decided whether the DCR should be approved or | | |
| | rejected. In case the DCR is to be rejected, the | | |
| | human steward provides appropriate rejection | | |
| | comments for business users to understand rationale | | |
| | for rejection | | |
| 5 | The human steward performs a check on whether | 1 | minute |

customer record has updated information based on
the DCR approval and then closes out the request

In an embodiment of the present invention, the event handler 102 invokes the sequencer 104 when the second event associated with the data change request is identified. The sequencer 104 invokes the connection unit 108 to get connected to the third-party websites and a web scrapping unit 110 to extract additional information from the connected third-party websites for resolving the data change request. The event handler 102 then sends the additional information to the intelligent analytical unit 123 for parsing the additional information from structured and unstructured content extracted from the third-party websites and validating the data change request.

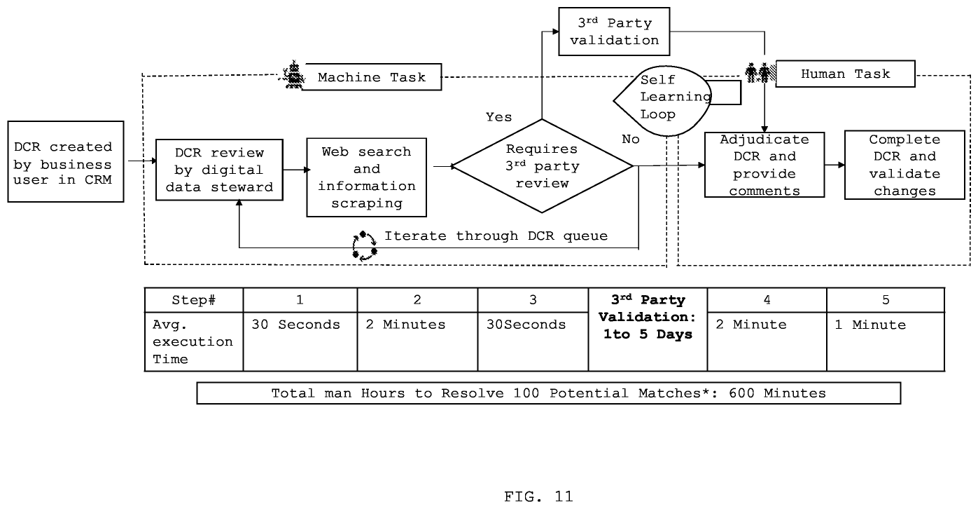

Table 5 and FIG. 11 illustrate a DCR summary generated by the system 100, in accordance with another embodiment of the present invention.

TABLE 5

| Step | | Time Taken | |
|---|---|---|---|
| No. | Step Details | (Average) | |
| 1 | The digital data stewardship system 100 uses | 30 | seconds |
| | information on DCR to identify type of the DCR | | |
| | 1. New Customer request - Request to approve a | | |
| | new HCP in the customer universe. | | |
| | 2. Edit Customer request - Request to approve | | |
| | changes to a customer such as specialty, status, | | |
| | address addition or inactivation etc. | | |
| 2 | The digital data stewardship system 100 performs a | 2 | minutes |
| | web search for the HCP. The search is carried out in | | |
| | the following sequence: | | |
| | 1. 3rd Party data provider websites (IQVIA or | | |
| | MedPro) | | |
| | 2. Government Healthcare databases (NPPES) | | |
| | 3. Private Company websites (Hospital websites) | | |
| | Information identified is captured by the system 100 | | |
| | through web scrapping and used for decision making | | |
| | on subsequent step | | |
| 3 | The digital data stewardship system 100 decides | 30 | seconds |
| | whether a 3rd party data provider primary review is | | |
| | required to validate the DCR. Based on this, the | | |
| | system 100 shares the DCR along with the additional | | |
| | information captured (NPI, phone numbers, additional | | |
| | addresses etc.). The system 100 then routes it for | | |
| | review by 3rd party provider either through API calls | | |
| | or creation of a batch file that is dropped to an sFTP | | |
| | location for the 3rd party provider to pick up (example | | |
| | IQVIA or MedPro) | | |
| 4 | The 3rd party provider validates request and shares | N/A (since its | |
| | response back | outside the purview | |
| | | of the system 100) | |
| 5 | The digital data stewardship system 100 reviews | 2 | minutes |
| | response back from the 3rd party provider. Based on | | |
| | the response, the system 100 decides whether the DCR | | |
| | should be approved or rejected. In case the DCR is to | | |
| | be rejected, the system 100 provides appropriate | | |
| | rejection comments for business user to understand | | |
| | rationale for rejection. | | |
| | The decision taken by the system 100 based on | | |
| | information shared back by the 3rd party is used to | | |
| | train ML decision model in the system 100 | | |
| 6 | The digital data stewardship system 100 performs a | 1 | Minute |

check on whether the customer record has updated
information based on the DCR approval and then
closes out the request

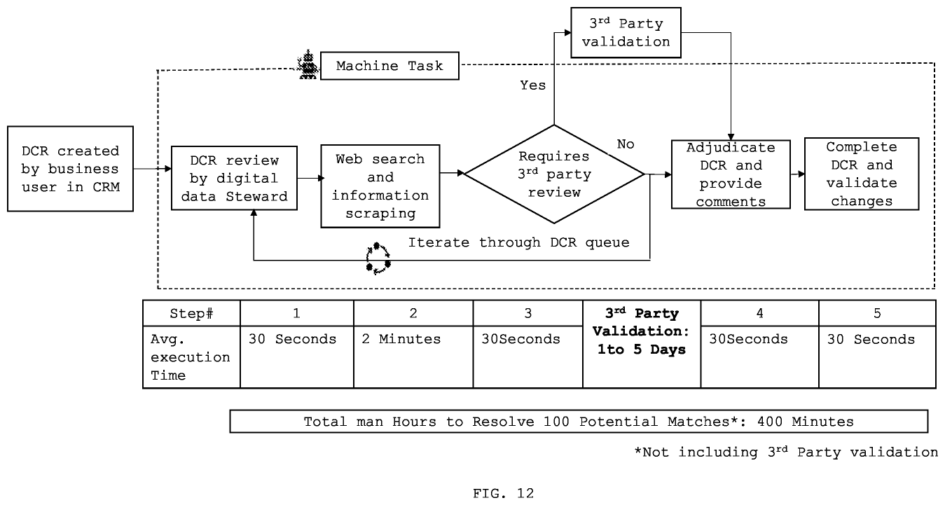

Table 6 and FIG. 12 illustrate a fully automated DCR resolution performed by system 100, in accordance with an embodiment of the present invention.

TABLE 6

| Step | | Time Taken | |
|---|---|---|---|
| No. | Step Details | (Average) | |
| 1 | The digital data stewardship system 100 uses the | 30 | seconds |
| | information on the DCR to identify the type of the | | |
| | DCR | | |
| | 1. New Customer request - Request to approve a | | |
| | new HCP in the customer universe | | |
| | 2. Edit Customer request - Request to approve | | |
| | changes to a customer such as specialty, | | |
| | status, address addition or inactivation etc. | | |
| 2 | The digital data stewardship system 100 performs a | 4 | minutes |
| | web search for the HCP. The research is carried out | | |
| | in the following sequence | | |
| | 1. 3rd Party data provider websites (IQVIA or | | |
| | MedPro) | | |
| | 2. Government Healthcare databases (NPPES) | | |
| | 3. Private Company websites (Hospital | | |
| | websites). Information identified is captured | | |
| | by the digital steward through web scrapping | | |
| | and used for decision making on the next step | | |
| 3 | The digital data stewardship system 100 decides | 30 | seconds |
| | whether a 3rd party data provider primary review is | | |
| | required to validate the DCR. Based on this, the | | |
| | digital data stewardship system 100 shares the DCR | | |
| | along with the additional information captured (NPI, | | |
| | phone numbers, additional addresses etc.). The digital | | |
| | data stewardship system 100 then routes it for review | | |
| | by 3rd party provider either through API calls or | | |
| | creation of a batch file that is dropped to a Secure | | |
| | File Transfer Protocol (SFTP) location for the 3rd | | |
| | party provider to pick up (example IQVIA or | | |
| | MedPro) | | |
| 4 | The 3rd Party provider validates the request and | N/A (since its | |
| | shares response back | outside the purview | |
| | | of the companies' | |
| | | data stewards) | |
| 5 | The digital data stewardship system 100 uses a ML | 30 | seconds |
| | model established based on prior human stewardship | | |
| | to adjudicate the DCR. The DCR is either approved | | |
| | or rejected. For rejections, the digital data | | |
| | stewardship system 100 specifies appropriate | | |
| | comment based on the output of the learning model | | |
| 5 | The digital data stewardship system 100 ensures that | 30 | seconds |

customer data is in sync with DCR request and closes
out the request

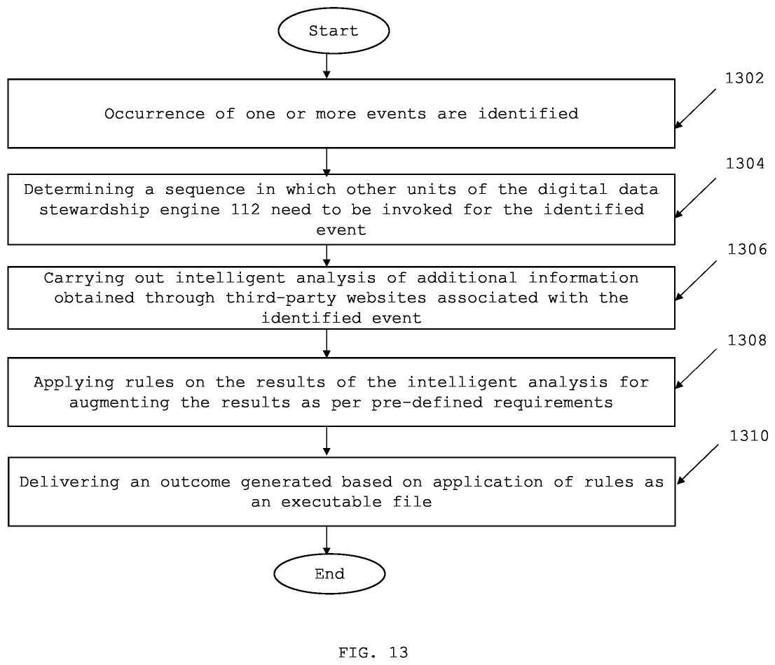

FIG. 13 is a flowchart illustrating a method for an artificial intelligence based optimized data stewardship, in accordance with an embodiment of the present invention.

At step 1302, occurrence of one or more events are identified. In an embodiment of the present invention, the events are identified based on nature of the events. In an exemplary embodiment of the present invention, the one or more events may be a first event including an update of the MDM system 118 match queue. Typically, a match queue of the MDM system 118 includes potential match records which are not a definite match and require resolution. The updating of the match queue by the MDM system 118 triggers an event, which is recognized as the updating of the match queue.

In another exemplary embodiment of the present invention, the one or more events may be a second event including a data change request made to the MDM system 118. Examples of data change request include requests made to the MDM system 118 around various data attributes including, but are not limited to, adding a new entity, modifying entity profile attributes, and removing inactive entities across various business functions of an organization, for instance, life sciences organization such as commercial functions, business functions, research and development, manufacturing, supply chain operations. Examples of entities include, but are not limited to, healthcare practitioners, healthcare organization, patient product, supplier, vendor, CRO site studies product, supplier plant material, distributer material, logistics partners etc. In another exemplary embodiment of the present invention, the one or more events may include a third event including a user input received by the MDM system 118 or the digital data stewardship engine 112. In an embodiment of the present invention, the events are triggered for taking actions on the events based on event triggers. The event triggers include time-based triggers or on-demand triggers.

At step 1304, a sequence in which other units of the digital data stewardship engine 112 need to be invoked for the identified event is determined. In an exemplary embodiment of the present invention, if the first event i.e., MDM match queue update (potential match queue) is identified then a sequence of actions are implemented for invocation of the other units of the digital data stewardship engine 112 for the potential match scenario. Firstly, the connection unit 108 is invoked to get connected to the third-party websites. Secondly, the web scrapping unit 110 is invoked to extract additional information from the connected third-party websites for resolving the potential match dataset.

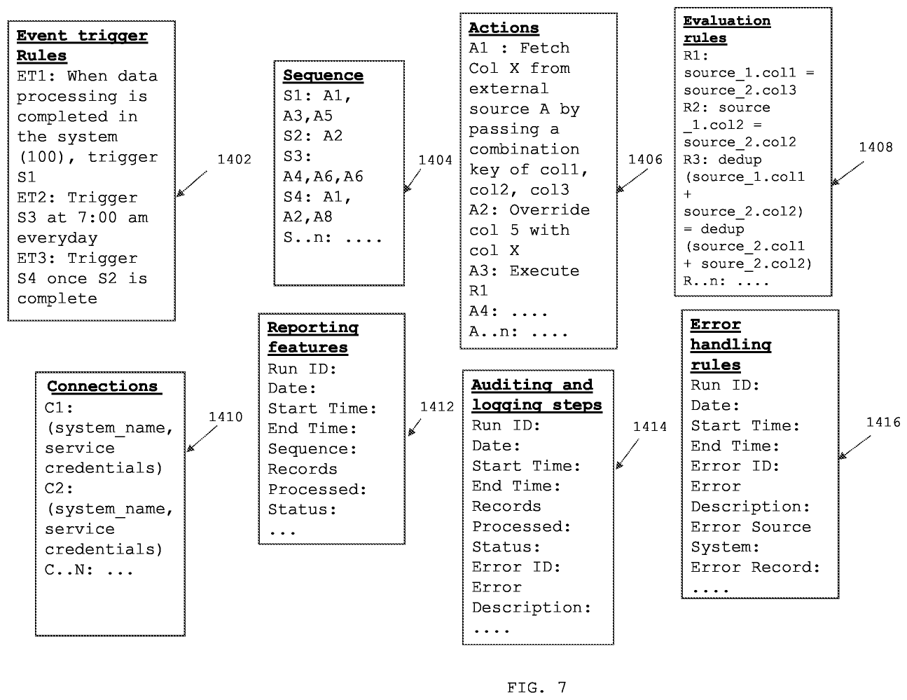

At step 1306, intelligent analysis of additional information obtained through third-party websites associated with the identified event is carried out. In an embodiment of the present invention, natural language processing is employed to parse the additional information that includes structured and unstructured data. In an exemplary embodiment of the present invention, in case of potential match scenario, matched dataset corresponding to the potential match dataset from the additional information is detected and text associated with the additional information is extracted. In an example, data associated with healthcare practitioners are matched on NPPES, IQVIA or MedPro portals and additional information such as National Provider Identification (NPI) number, Drug Enforcement Agency (DEA) etc. are extracted for determining a match. The additional information is then classified. For example, a 10-digit number identified on NPPES website is automatically classified as NPI by the intelligent analytical unit 123. In an exemplary embodiment of the present invention, machine learning-based algorithm is used for intelligent classification of information for further usage. After classification, machine learning-based contextual matching is employed for resolving the potential matches in the potential match queue. In an exemplary embodiment of the present invention, contextual matching is employed to identify duplicates of a specific entity type. For example, healthcare practitioner specific attributes (e.g., first name, last name, address, identifiers etc.) are employed for the contextual matching. FIG. 7 illustrates actions performed by the system 100 to process the potential match record for applying rules to resolve the potential match record, in accordance with an embodiment of the present invention.

In an exemplary embodiment of the present invention, machine language-based response models are employed to predict outcomes based on results of the contextual matching. In another exemplary embodiment of the present invention, patterns in the results of the contextual match are used to refine the machine learning-based response models without any human intervention, as unsupervised learning. In yet another exemplary embodiment of the present invention, previously analysed and resolved datasets are used as initial learning for the machine learning-based response models, as supervised learning. For example, the machine learning-based response models are fed with prior data steward resolution of potential match datasets to train the machine learning-based response models on healthcare practitioner or healthcare organization matches.

At step 1308, rules are applied on the results of the intelligent analysis for augmenting the results as per pre-defined requirements. In an exemplary embodiment of the present invention, in case of the potential match scenario, results of the contextual matching are augmented and outcomes i.e., resolved potential matched records are generated which are consistent with organization defined business rules.

At step 1310, an outcome generated based on application of rules is delivered as an executable file. In an embodiment of the present invention, in case of the potential match scenario, merged dataset of the resolved potential match record is created for delivering as an executable file.

Advantageously, the data stewardship system 100 provides for efficient, accurate and precise identification and resolution of potential match records with minimum or no human intervention. The data stewardship system 100 provides for a system with faster processing speed and minimum memory utilization.

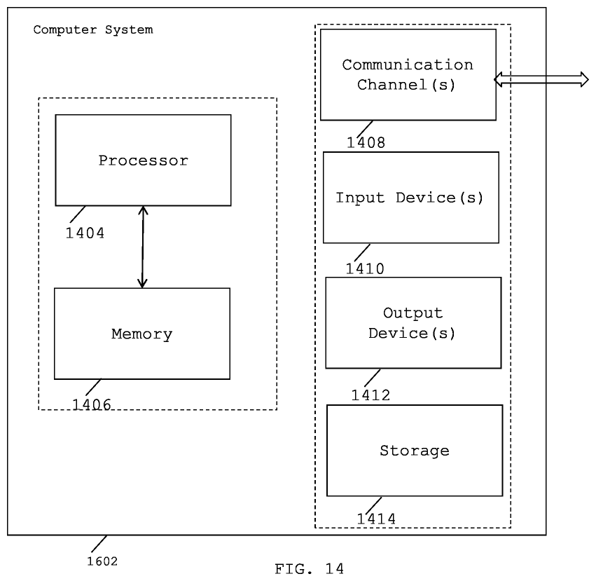

FIG. 14 illustrates an exemplary computer system in which various embodiments of the present invention may be implemented. The computer system 1402 comprises a processor 1404 and a memory 1406. The processor 1404 executes program instructions and is a real processor. The computer system 1402 is not intended to suggest any limitation as to scope of use or functionality of described embodiments. For example, the computer system 1402 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 1406 may store software for implementing an embodiment of the present invention. The computer system 1402 may have additional components. For example, the computer system 1402 includes one or more communication channels 1408, one or more input devices 1410, one or more output devices 1412, and storage 1414. An interconnection mechanism (not shown) such as a bus, controller, or network, interconnects the components of the computer system 1402. In an embodiment of the present invention, operating system software (not shown) provides an operating environment for various software executing in the computer system 1402, and manages different functionalities of the components of the computer system 1402.

The communication channel(s) 1408 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media. The input device(s) 1410 may include, but not limited to, a keyboard, mouse, pen, joystick, trackball, a voice device, a scanning device, touch screen or any another device that is capable of providing input to the computer system 1402. In an embodiment of the present invention, the input device(s) 1410 may be a sound card or similar device that accepts audio input in analog or digital form. The output device(s) 1412 may include, but not limited to, a user interface on CRT or LCD, printer, speaker, CD/DVD writer, or any other device that provides output from the computer system 1402.

The storage 1414 may include, but not limited to, magnetic disks, magnetic tapes, CD-ROMs, CD-RWs, DVDs, flash drives or any other medium which can be used to store information and can be accessed by the computer system 1402. In an embodiment of the present invention, the storage 1414 contains program instructions for implementing the described embodiments.

The present invention may suitably be embodied as a computer program product for use with the computer system 1402. The method described herein is typically implemented as a computer program product, comprising a set of program instructions which is executed by the computer system 1402 or any other similar device. The set of program instructions may be a series of computer readable codes stored on a tangible medium, such as a computer readable storage medium (storage 1414), for example, diskette, CD-ROM, ROM, flash drives or hard disk, or transmittable to the computer system 1502, via a modem or other interface device, over either a tangible medium, including but not limited to optical or analogue communications channel(s) 1408. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A system for implementing artificial intelligence-based optimised data stewardship, the system comprising:
a memory for storing program instructions;
a processor executing instructions stored in the memory, and a digital data stewardship engine executed by the processor and configured to:
identify one or more events based on nature of the events;
determine a sequence for invoking one or more units of the digital data stewardship engine based on the identified event;
perform machine learning-based intelligent analysis on additional information obtained through third-party websites associated with the identified event;
apply rules on results of the intelligent analysis for augmenting the results as per pre-defined requirements; and
deliver an outcome generated based on application of rules as an executable file.

2. The system as claimed in claim 1, wherein the one or events include a first event associated with a Master Data Management system (MDM) system match queue update, a second event associated with a data change request, and a third event associated with user input received by the MDM system or the digital data stewardship engine.

3. The system as claimed in claim 1, wherein the digital data stewardship engine is communicatively connected to the MDM system and third-party websites through a connection unit in the digital data stewardship engine.

4. The system as claimed in claim 3, wherein the connection unit allows data connection into and out of the digital data stewardship engine via a plurality of batch connection streams and/or Application Program Interface (API) based exchange, allows inbound and outbound connection to the MDM system, establishes a plurality of connections to the MDM system's backend database tables as well as API based calls depending on specifics of the MDM system, and allows inbound data feeds from the third-party websites.

5. The system as claimed in claim 2, wherein the digital data stewardship engine comprises an event handler for actively listening to occurrence of the one or more events for identifying the events, and wherein the event handler is triggered for taking actions on the events based on event triggers including time-based triggers or on-demand triggers.

6. The system as claimed in claim 5, wherein the event handler, upon triggering, invokes a sequencer in the digital data stewardship engine for determining sequence in which other units of the digital data stewardship engine need to be invoked for the identified event.

7. The system as claimed in claim 6, wherein in the event the event handler identifies the first event associated with MDM system match queue update, the sequencer invokes a connection unit to get connected to the third-party websites and a web scrapping unit in the digital date stewardship engine to extract additional information from the connected third-party websites for resolving a potential match dataset in a match queue.

8. The system as claimed in claim 7, wherein the event handler sends the additional information to an intelligent analytical unit in the digital data stewardship engine for analysis, wherein the intelligent analytical unit parses the additional information from structured and unstructured content extracted from the third-party websites, implements an information extractor to detect matched dataset corresponding to the potential match dataset from the additional information to extract text associated with the additional information, and classifies the additional information employing machine learning-based algorithm for intelligent classification of the additional information.

9. The system as claimed in claim 8, wherein the intelligent classification unit performs machine learning-based contextual matching for resolving the potential matches in the potential match queue including identifying duplicates of a specific entity type, and wherein the contextual matching includes resolving the potential matches in the match queue based on discrete actions and evaluation rules associated with each of the actions stored in the intelligent analytical unit.

10. The system as claimed in claim 9, wherein the intelligent analytical unit employs machine language-based response models to predict outcomes based on results of the contextual matching, uses patterns in results of contextual match to refine the machine learning-based response models without any human intervention as unsupervised learning and uses previously analysed and resolved datasets as initial learning for the machine learning-based response models as supervised learning.

11. The system as claimed in 9, wherein the event handler invokes an error handler in the digital data stewardship engine for detecting errors in the processing steps of the digital data stewardship engine, and invokes an audit log for tracing a log for every execution run of the digital data steward engine.

12. The system as claimed in 9, wherein the event handler invokes a rule unit in the digital data stewardship engine for processing the results of contextual matching, and wherein the rule unit augments results of the contextual matching by the intelligent analytical unit and generate outcomes consistent organization defined business rules.

13. The system as claimed in claim 9, wherein the event handler creates a merged dataset of the resolved potential match record for delivering as an executable file via the output unit.

14. The system as claimed in claim 5, wherein the event handler invokes a sequencer when the second event associated with data change request is identified, and wherein the sequencer invokes a connection unit to get connected to third-party websites and a web scrapping unit to extract additional information from the connected third-party websites for resolving the data change request.

15. The system as claimed in claim 14, wherein the event handler sends the additional information to an intelligent analytical unit for parsing the additional information from structured and unstructured content extracted from the third-party websites and validating the data change request.

16. The system as claimed in claim 9, wherein the data stewardship engine is configured to analyze efficacy of the actions and the evaluation rules in terms of efficiency and accuracy of results and overrides and updates the actions and the evaluation rules continuously.

17. A method for implementing artificial intelligence-based optimised data stewardship, the method implemented by a processor executing program instructions stored in a memory, the method comprising:
identifying one or more events based on nature of the events;
determining a sequence for invoking one or more units of the digital data stewardship engine based on the identified event;
performing machine learning-based intelligent analysis on additional information obtained through third-party websites associated with the identified event;
applying rules on results of the intelligent analysis for augmenting the results as per pre-defined requirements; and
delivering an outcome generated based on application of rules as an executable file.

18. The method as claimed in claim 17, wherein the one or events include a first event associated with a Master Data Management system (MDM) system match queue update, a second event associated with a data change request, and a third event associated with associated with user input received by the MDM system or the digital data stewardship engine.

19. The method as claimed in claim 17, wherein the step of identifying the one or more events comprises actively listening to the occurrence of the one or more events for identifying the events, and triggering actions on the identified events based on event triggers including time-based triggers or on-demand triggers.

20. The method as claimed in claim 18, wherein in the event the first event associated with MDM system match queue update is identified, a connection unit is invoked to get connected to third-party websites and a web scrapping unit is invoked to extract additional information from the connected third-party websites for resolving a potential match dataset in the match queue.

21. The method as claimed in claim 20, wherein the step of performing machine learning-based intelligent analysis comprises parsing the additional information from structured and unstructured content extracted from the third-party websites, implementing an information extractor to detect matched dataset corresponding to the potential match dataset from the additional information to extract text associated with the additional information, and classifying the additional information employing machine learning-based algorithm for intelligent classification of the additional information.

22. The method as claimed in claim 21, wherein machine learning-based contextual matching includes identifying duplicates of a specific entity type, and wherein the contextual matching includes resolving the potential matches in the match queue based on discrete actions and evaluation rules associated with each of the actions.

23. The method as claimed in claim 21, wherein machine language-based response models are employed to predict outcomes based on results of the contextual matching, employing patterns in the results of the contextual match to refine the machine learning-based response models without any human intervention as unsupervised learning, employing previously analysed and resolved datasets as initial learning for the machine learning-based response models as supervised learning.

24. The method as claimed in 17, wherein errors in the processing steps of the digital data stewardship engine are detected, and wherein a trace log for every execution run of a digital data steward engine is determined.

25. The method as claimed in 17, wherein the step of applying rules on the results of the intelligent analysis comprises augmenting results of the contextual matching to generate outcomes consistent with organization defined business rules.

26. The method as claimed in claim 20, wherein the step of delivering an outcome generated based on application of rules comprises creating a merged dataset of the resolved potential match record for delivering as an executable file.

27. The method as claimed in claim 18, wherein when the second event associated with the data change request is identified, a connection unit is invoked to get connected to the third-party websites and a web scrapping unit is invoked to extract additional information from the connected third-party websites for resolving the data change request.

28. The method as claimed in claim 27, wherein the additional information comprising structured and unstructured content extracted from the third-party websites is parsed and analysed to validate the data change request.

29. A computer program product comprising:
a non-transitory computer-readable medium having computer program code stored thereon, the computer-readable program code comprising instructions that, when executed by a processor, causes the processor to:
identify one or more events based on nature of the events;
determine a sequence for invoking one or more units of a digital data stewardship engine based on the identified event;
perform machine learning-based intelligent analysis on additional information obtained through third-party websites associated with the identified event;
apply rules on results of the intelligent analysis for augmenting the results as per pre-defined requirements; and
deliver an outcome generated based on application of rules as an executable file.
